(19) United States
(12) Patent Application Publication
(10) Pub. No.: US 2016/0357802 A1
(43) Pub. Date: Dec. 8, 2016

(54) METHOD FOR UPDATING A DATABASE

(71) Applicant: Robert Bosch GmbH, Stuttgart (DE)

(72) Inventors: Reinhard MESCHENMOSER, Hannover (DE); Dirk LUEDTKE, Barcelona (ES)

(21) Appl. No.: 15/241,194

(22) Filed: Aug. 19, 2016

Related U.S. Application Data
(63) Continuation of application No. 12/514,021, filed on Aug. 16, 2010, now abandoned.

(30) Foreign Application Priority Data
Nov. 7, 2006 (DE) 10 2006 052 482.9

(51) Int. Cl. G06F 17/30

(52) U.S. Cl. CPC G06F 17/30356; G06F 17/30371; G06F 17/30377

(57) ABSTRACT

In a method for updating a database by transmitting a version of database segments, the database is divided into individual segments. To reduce the quantity of data to be transmitted and to reduce the computing expenditure, the segments are divided into segments to be updated explicitly and segments to be updated implicitly and a segment that is to be updated implicitly is updated together with a segment that is to be updated explicitly. Furthermore, an appropriately developed database installation is specified.

### CROSS-REFERENCE TO RELATED APPLICATIONS

The present application is a continuation application of U.S. patent application Ser. No. 12/514,021, filed on Aug. 16, 2010, which is a national phase of International Patent Application No. PCT/EP2007/059659, filed Sep. 13, 2007, and claims priority to German Patent Application No. DE 10 2006 052 482.9, filed on Nov. 7, 2006, all of which are hereby incorporated by reference in their entireties in the accompanying patent application.

### FIELD OF THE INVENTION

The present invention relates to a method for updating a database by transmitting a version of database segments, the database being divided into individual segments, as well as to an appropriately developed database installation.

### BACKGROUND INFORMATION

In various systems or devices, databases of any type of data format form the basis for ascertaining other variables or information. In navigation systems, for example, information about roads, bridges, ferries and the like is stored in appropriately designed databases or database installations in the form of writeable and/or readable data memories, which may be stored, for example, on a CD-ROM, in order to be able to calculate an optimum travel route to a destination specified by the user of the navigation system on the basis of the database and the currently ascertained position and to output the appropriate travel direction instructions while traveling.

In this connection, it is necessary always to keep the database up to date since the possible travel routes change constantly, for example when a new expressway section is opened.

For this purpose, the provider of the database is known to prepare a new version of the database and to update the database in a device using this version. The new version may be transferred to a storage medium or the new version of the database is transmitted to the respective system via the Internet or, in the case of a navigation system, wirelessly via a radio link. In principle, it is also possible to transmit only individual elements that have actually changed or binary differences with respect to older versions in order to minimize the expenditure for a data transfer. Of course, any transmission media may be used for this purpose.

When updating a database, one requirement is that the database remain internally consistent even after the update. This means that no data or segments of the database may violate any of the consistency conditions stipulated in the specification of the database. An example of such a condition is a reference which within the database must not be directed to an element that was deleted in an update.

A frequent reason for the violation of such a consistency condition is that a part of the database was updated, but that dependencies between this part and other parts of the database that were not updated are not taken into account. Although this could be remedied by replacing the entire database, this would require a considerable expenditure and, in the case of a wireless radio link, a considerable and cost-intensive time requirement for downloading the up-to-date database.

A conventional solution to this problem is to divide a database into individual segments that are updated independently of one another. For this purpose, the database is divided into non-overlapping parts or segments, which may each have different update versions. When updating individual segments, however, one must still pay attention to the fact that mutual dependencies must be taken into account in order to obtain a consistent database.

An undesired result of partial updating is the so-called “avalanche effect.” Even if only a part or segment of the database is to be updated, it may become necessary to update multiple segments of the database subsequently if an updated segment contains references or relations to these other segments. Although this effect may be limited by dividing the database into smaller units, this would result in the database being made up of many different segments that each have a different update level. This substantially increases the expenditure necessary for monitoring the updating of the database. Additionally, there is the problem that in a computing center, in which the updated database versions are prepared, there is usually no information available as to which versions of the database currently exist on a user's device.

### SUMMARY

Example embodiments of the present invention provide a method for updating a database of the type mentioned at the outset, by which it is possible in a simple manner to update a database, at least partially, without the administrative expenditure for monitoring the update process becoming too great. Furthermore, it must be ensured that the database is internally consistent. Moreover, an appropriately developed database installation shall be specified.

According to example embodiments of the present invention, a database is divided, e.g., in a conventional manner, into smaller parts, units or segments, and that the individual segments of the database are differentiated as to whether they are to be categorized as segments to be updated explicitly or implicitly. Segments to be updated implicitly will be updated only in together with the segments to be updated explicitly since relations exist from the implicit segments to the explicit segments. This means that a change of an explicit segment directly requires or entails updating a segment to be updated implicitly. The segments to be updated implicitly are updated within the database or within the device and this is done for example by an update compiler.

It is clear that a segment of the database may have an arbitrary size all the way down to individual data or attributes. Each segment is assigned a version or an update level, which is stored in an update compiler in the computing center. When an update is to be performed, a new version is transmitted only for the segments to be updated explicitly and is stored in the database of a mobile navigation device for example, which received the updated version wirelessly. For the other segments to be updated implicitly, no up-to-date version is transmitted, these being updated in the database itself as a function of the changes of the explicit segments. The corresponding changes of these implicit segments may be reproduced, however, in the computing center because there the parameters of the utilized databases are known.

To this end, a database installation, for example in a navigation system, has a database to which database segments received by a receiving device may be supplied. An update compiler is provided in the database installation, which may take the form of hardware and/or software, and by which the segments of the database to be updated implicitly are updated on the basis of the versions of the database segments received from a computing center.

According to example embodiments of the present invention, avalanche effects are largely avoided since the number of segments to be updated is substantially reduced by the division into segments to be updated explicitly and segments to be updated implicitly. The updates of the segments to be updated implicitly are not omitted in the process. Rather, segments to be updated implicitly are no longer able to trigger updates. In addition, substantially fewer data have to be transmitted since an update of the segments to be updated implicitly no longer needs to be transmitted. Furthermore, no storage spaces need to be held in reserve in the database for the updated versions of the segments to be updated implicitly since these are renewed automatically. Moreover, these segments are omitted in monitoring the different versions such that the computing expenditure is reduced significantly.

The division into segments to be updated explicitly and segments to be updated implicitly occurs already when the specifications of the database are prepared, it being also possible that various explicit segments are dependent on one another. This means that updating an explicit segment entails updating another explicit segment that depends on the first or that has a relation to it.

The segments to be updated implicitly on the other hand may only be updated together with the explicit segments, a version of a segment to be updated implicitly corresponding exactly to the update level of the associated explicit segment. Of course, it is also possible that a segment to be updated implicitly depends on various explicit segments, in which case the update level of the respectively most recent explicit segment is decisive.

Preferably, an independent segment of the database is to be updated explicitly or expressly. This means that in this case an update is performed only if this is absolutely necessary in order to keep the quantity of data to be transmitted as small as possible. This prevents such a segment from being updated implicitly together with other segments.

In the case of segments that depend only on one another or that refer only to one another, one of these is categorized as to be updated explicitly and the other(s) as to be updated implicitly. Thus, updating only the one segment categorized as explicit entails only the transmission of a small quantity of data and only a low computing and monitoring expenditure since the other segment(s) is/are updated implicitly.

It is evident that the method may be used in any databases in various devices and applications that may be updated in an arbitrary manner. For example, the method may be used in databases of a navigation system since the method in particular does not overload the capacity for the wireless transmission of data. The database of a navigation system stores the road network in various scales of magnification. On the smallest scale, all roads, paths and the like are represented. On the largest scale, by contract, only the expressways are represented for example. Between these, there are arbitrarily many different scales or magnifications on a display for example.

If the route of an expressway is changed, for example, or a new expressway section is opened, then this information must be present in all magnification scales because otherwise the representation of the expressway for example in different scales of magnification would be inconsistent. Accordingly, it is necessary to perform the update of the expressway explicitly at least in the smallest magnification scale and to perform an implicit update for the other magnification scales. Thus the consistency of the database is ensured since the various magnifications are updated jointly if required. On the other hand, it is ensured that in the event of a change in a larger scale this change is also represented in a magnified representation at a smaller scale, if the resolution is still sufficient.

Preferably, a database installation according to example embodiments of the present invention is developed so as to be able to implement the method described above.

Example embodiments of the present invention are explained in more detail below with reference to the figures.

### BRIEF DESCRIPTION OF THE DRAWINGS

FIG. 1 illustrates updating a database,

FIG. 2 illustrates a database divided into segments,

FIG. 3 illustrates various dependencies of the segments, and

FIG. 4 illustrates a database installation.

### DETAILED DESCRIPTION

The schematic representation in FIG. 1 shows the basic procedure when updating a database 1. In a computing center 2, various updated versions of a database 1 are prepared, the various versions of database segments a, b, c being transmitted in an arbitrary manner to database 1 that is spatially separated from computing center 2. The transmission may occur on a storage medium, for example, via the Internet or wirelessly, inter alia, to a mobile navigation device.

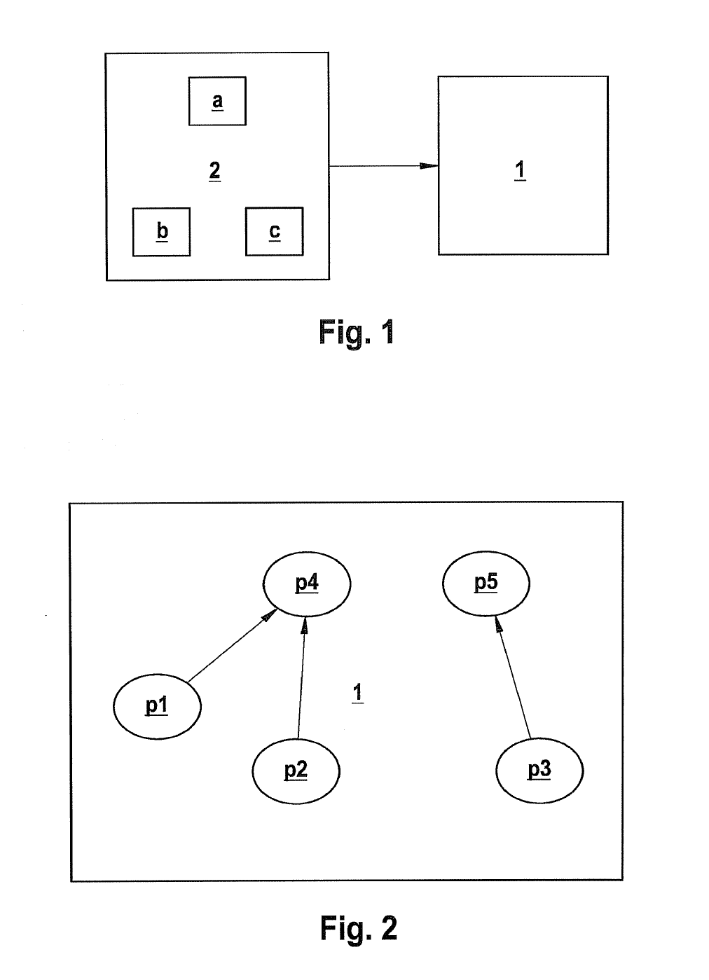

FIG. 2 shows the division of a database 1 into various segments p1, p2, p3, p4, p5. For this purpose, each of the segments p1 through p5 may have a different update level, depending on which version of database segments a, b, c were transmitted from computing center 2 to database 1 of a navigation device for example. In this exemplary embodiment, segments p1, p2 depend on segment p4 and segment p3 depends on segment p5 or these segments are in relation to one another.

This means that updating segment p3 entails updating segment p5.

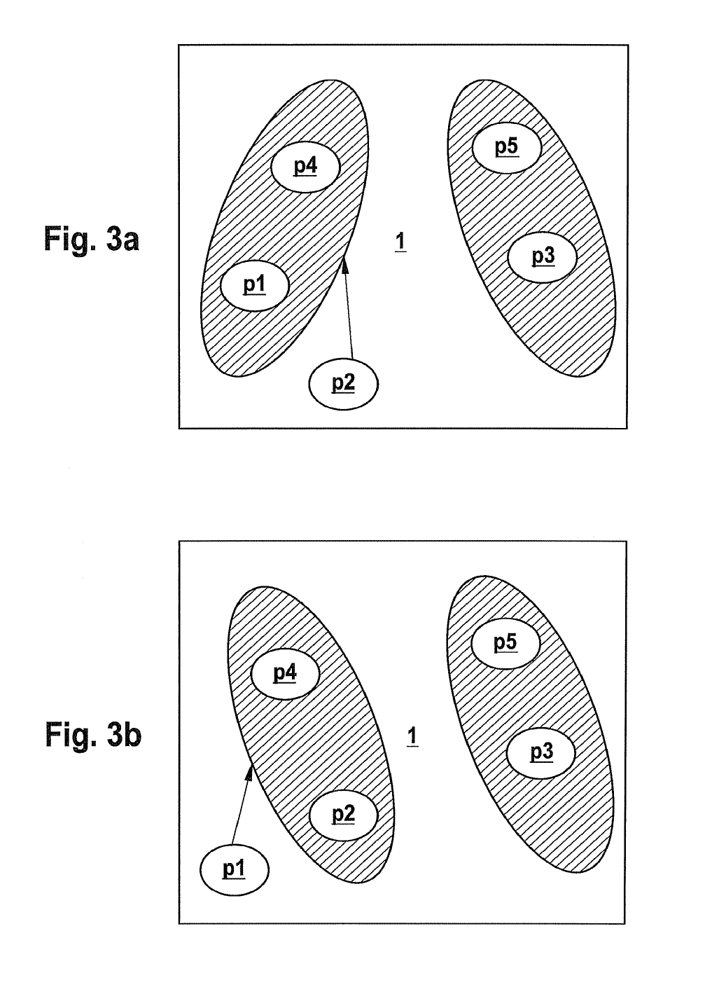

FIG. 3 shows two examples of database 1, segments p4 and p5 being categorized as segments to be updated implicitly. Since segment p5 has only a dependent relation to segment p3, it is definitely updated together with segment p3. It is different, however, for segment p4, which has a dependency on or relation to both segment p1 as well as segment p2. Segment p4 is updated together with segment p1 as shown in FIG. 3a, if segment p1 was updated by the transmission of data. If segment p2, however, as shown in FIG. 3b, has been updated, then segment p4 is updated implicitly together with segment p2 within the database, for example by an update compiler in the database.

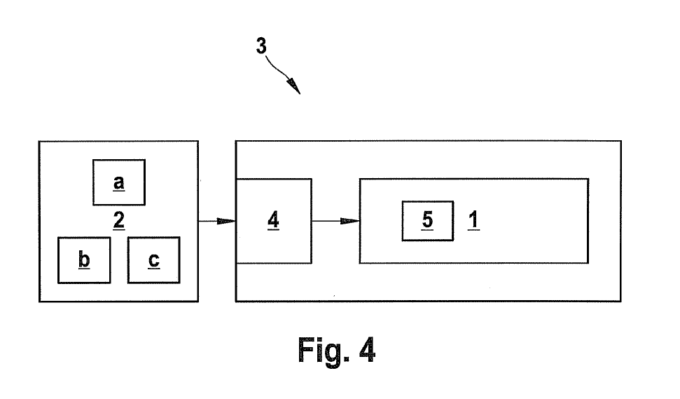

FIG. 4 depicts a database installation 3, which is essentially made up of a database 1 and a receiving device 4. With the aid of receiving device 4 it is possible, preferably wirelessly, to receive and transmit to database 1 versions of database segments a, b, c, which were transmitted from a central computing center 2, as indicated by the connecting arrows. Furthermore, an update compiler 5 is developed in database 1 as hardware and/or software, which is used for example to update segments p4, p5 of database 1 from FIG. 3 which are to be updated implicitly.

1-5. (canceled)

6. A method for updating a database, comprising:
dividing the database into individual segments;
dividing the segments into segments to be updated explicitly and segments to be updated implicitly, wherein each segment to be updated implicitly is assigned a relationship with at least one segment to be updated explicitly;
transmitting, when an update is to be performed, a new version only of at least one of the segments to be updated explicitly to the database;
at the database, explicitly updating the at least one of the segments to be updated explicitly using the new version; and
at the database, implicitly updating each segment to be updated implicitly which has an assigned relationship with any of the segments to be updated explicitly for which a new version was transmitted;
wherein each implicitly updated segment is updated as a function of changes made to a respectively assigned explicitly updated segment, without using a new version of the implicitly updated segment,
wherein each of the segments is assigned a version or an update level, which is stored in an update compiler in a database installation,
wherein, for the other segments to be updated implicitly, no up-to-date version is transmitted, the other segments being updated in the database itself as a function of the changes of the explicit segments,
wherein the database installation includes the database to which database segments received by a receiving device are suppliable, and having the update compiler, by which the segments of the database to be updated implicitly are updated based on versions of the database segments received from a computing center.

7. The method according to claim 6, wherein an independent segment of the database is updated explicitly.

8. The method according to claim 6, wherein in the case of segments that depend only on one another, one of the segments is categorized as to be updated explicitly and other segments are categorized as to be updated implicitly.

9. The method according to claim 6, wherein a database of a navigation system is updated by explicitly updating segments that correspond to a low magnification scale and implicitly updating related segments that correspond to a higher magnification scale.

10. The method according to claim 6, wherein corresponding changes of the implicit segments are reproduce-able in the computing center.

11. The method according to claim 6, wherein a segment to be updated implicitly depends on explicit segments, in which case an update level of a respectively most recent explicit segment is decisive.

12. The method according to claim 6, wherein for segments that depend only on one another or that refer only to one another, one of the segments is categorized as to be updated explicitly and remaining segments are to be updated implicitly.

13. The method according to claim 6, wherein the database is of a navigation device, and wherein if a route of an expressway is changed or a new expressway section is opened, then this information must be present in all magnification scales, so that an update of the expressway is performed explicitly at least in the smallest magnification scale and performed as an implicit update for remaining magnification scales.

14. A database installation, comprising:
a reception device to receive a new version of at least one database segment to be updated explicitly, wherein the new version of the at least one database segment to be updated explicitly is transmitted from a computing center; and
a database divided into individual segments including segments to be updated explicitly and segments to be updated implicitly, wherein each segment to be updated implicitly is assigned a relationship with at least one segment to be updated explicitly, the database including an update compiler adapted to:
explicitly update the at least one database segment to be updated explicitly using the new version; and
implicitly update each segment to be updated implicitly which has an assigned relationship with any of the segments to be updated explicitly for which a new version only was transmitted;
wherein each implicitly updated segment is updated as a function of changes made to a respectively assigned explicitly updated segment, without using a new version of the implicitly updated segment,
wherein each of the segments is assigned a version or an update level, which is stored in an update compiler in a database installation,
wherein, for the other segments to be updated implicitly, no up-to-date version is transmitted, the other segments being updated in the database itself as a function of the changes of the explicit segments, and
wherein the database installation includes the database to which database segments received by a receiving device are suppliable, and having the update compiler, by which the segments of the database to be updated implicitly are updated based on versions of the database segments received from a computing center.
